(19) United States
(12) Patent Application Publication
(10) Pub. No.: US 2017/0257922 A1
(43) Pub. Date: Sep. 7, 2017

(54) LIGHTING APPARATUS

(71) Applicant: PANASONIC INTELLECTUAL PROPERTY MANAGEMENT CO., LTD., Osaka (JP)

(72) Inventors: Yoko MATSUBAYASHI, Osaka (JP); Tohru HIMENO, Osaka (JP); Hiroko KOIWA, Osaka (JP); Naoko TAKEI, Osaka (JP); Makoto YAMADA, Osaka (JP)

(73) Assignee: PANASONIC INTELLECTUAL PROPERTY MANAGEMENT CO., LTD., Osaka (JP)

(21) Appl. No.: 15/447,760

(22) Filed: Mar. 2, 2017

(30) Foreign Application Priority Data
Mar. 3, 2016 (JP) 2016-041484

(51) Int. Cl. H05B 33/08; F21V 23/02; F21V 3/00

(52) U.S. Cl. CPC H05B 33/0857; F21V 3/00; F21V 23/02; H05B 33/0821; F21Y 2105/18

(57) ABSTRACT

A lighting apparatus includes first light emitting elements and second light emitting elements having chromaticity values in a same chromaticity range. A ratio of a greatest value of a spectral distribution of combined light in a range of 500 nm to 560 nm inclusive to a smallest value of the spectral distribution of the combined light in a range of 500 nm to 650 nm inclusive is 0.85 or less. The combined light is a combination of light emitted by the first light emitting elements and light emitted by the second light emitting elements.

### CROSS REFERENCE TO RELATED APPLICATION

This application claims the benefit of priority of Japanese Patent Application Number 2016-041484 filed on Mar. 3, 2016, the entire content of which is hereby incorporated by reference.

### BACKGROUND

1. Technical Field

The present disclosure relates to a lighting apparatus, and in particular to a lighting apparatus for correcting a change in visual performance due to aging.

2. Description of the Related Art

According to the arrival of an aging society, there has been a great demand for a comfortable environment for middle and older aged people. In particular, improvement in visual environment achieved by lighting is an urgent issue. It is thus necessary to clarify how lighting can correct a change in human visual system caused by aging. Examples of a change in visual performance due to aging mainly include (a) a fall in transmittance of a crystalline lens, in particular a fall in transmittance of a crystalline lens in a short wavelength range, and (b) a bleary eye (intraocular scattering) due to a cataract (a crystalline lens clouding over).

In order to address (a), lighting which increases a proportion of blue light that reaches a retina by intensifying light in a wavelength range where a transmittance of a crystalline lens falls, or in other words, by causing light to have a so-called high color temperature is recommended for middle and older aged people, as disclosed in Japanese Unexamined Patent Application Publication No. 2003-237464.

Furthermore, there is a method of intensifying blue light components in order to take also (b) into consideration, as disclosed in Japanese Unexamined Patent Application Publication No. H04-137305. Japanese Unexamined Patent Application Publication No. H04-137305 recommends lighting which reduces glare by mainly reducing light in a wavelength range (of at least 470 nm and at most 530 nm) which has strong influence on glare, and thus yields advantageous effects of allowing users to perceive high contrast, high lightness, and high color saturation.

Taking (b) into consideration, there is also a method of adjusting a color-variable wall in order to reduce intraocular scattering due to ambient light, as disclosed in Japanese Unexamined Patent Application Publication No. 2005-302500.

### SUMMARY

Here, there has been a demand for a lighting apparatus which allows middle and older aged people to perceive highly vivid colors while avoiding glare.

Accordingly, the present disclosure provides a lighting apparatus which prevents letters and objects that middle and older aged people observe from appearing to have lower color saturation.

A lighting apparatus according to an aspect of the present disclosure includes: first light emitting elements; and second light emitting elements having chromaticity values in a same chromaticity range as the first light emitting elements, wherein a spectral distribution of light emitted by the first light emitting elements includes a first peak wavelength in a range of 425 nm to 480 nm inclusive, and a second peak wavelength in a range of 500 nm to 560 nm inclusive, a spectral distribution of light emitted by the second light emitting elements includes a first peak wavelength in a range of 425 nm to 480 nm inclusive, a second peak wavelength in a range of 500 nm to 560 nm inclusive, and a third peak wavelength in a range of 580 nm to 650 nm inclusive, and a ratio of a greatest value of a spectral distribution of combined light in a range of 500 nm to 560 nm inclusive to a smallest value of the spectral distribution of the combined light in a range of 500 nm to 650 nm inclusive is 0.85 or less, the combined light being a combination of the light emitted by the first light emitting elements and the light emitted by the second light emitting elements.

According to the present disclosure, letters and objects that middle and older aged people observe are prevented from appearing to have lower color saturation.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective view illustrating a schematic structure of a lighting apparatus according to Embodiment 1;

FIG. 2 is an exploded perspective view illustrating a schematic structure of the lighting apparatus according to Embodiment 1;

FIG. 3 is a graph illustrating examples of spectral characteristics of first light emitting elements and second light emitting elements according to Embodiment 1;

FIG. 4 is a schematic diagram illustrating an example of arrangement of the first light emitting elements and the second light emitting elements according to Embodiment 1;

FIG. 5 is a block diagram illustrating a main control configuration of the lighting apparatus according to Embodiment 1;

FIG. 6 is a graph illustrating, when the ratio in number of the first light emitting elements to the second light emitting elements according to Embodiment 1 is changed, spectral distributions of combined light at the ratios in number;

FIG. 7 is a graph illustrating changes of relative intensity ratios at a first value and a third value of spectral distributions of light emitted by the light emitting elements having the ratios in number according to Embodiment 1, when the relative intensities at a second value are 1;

FIG. 8 is a table illustrating optical characteristics of the entire lighting apparatus at the ratios in number of the first light emitting elements to the second light emitting elements according to Embodiment 1:

FIG. 9 is a graph illustrating a relation between proportion in number of the first light emitting elements to the second light emitting elements and an efficiency percentage and a FCI percentage in FIG. 8;

FIG. 10 is an explanatory diagram illustrating a spectral distribution of light emitted by a standard light source, a filter for middle and older aged people, and a spectral distribution obtained by applying the filter for middle and older aged people to the spectral distribution of light from the standard light source, according to Embodiment 1;

FIG. 11 is a chromaticity coordinate graph showing outputs of chromaticity coordinates of a D65 light source in FIG. 10 and chromaticity coordinates of the D65 light source when the filter for middle and older aged people is applied;

FIG. 12 is a table illustrating optical characteristics of light emitted by third light emitting elements and test 1 light to test 3 light used for color mixture in a verification experiment;

FIG. 13 is a graph illustrating relations between a chroma difference obtained by the experiment and test 1 light to test 3 light, separately for middle aged people and maturing aged people;

FIG. 14 is a graph illustrating relations between test 1 to test 3 light and chroma differences for the four hues for middle aged people;

FIG. 15 is a graph illustrating a relation between the FCI percentage of illumination light and the correctness percentage of identifying a color of red paper, for middle aged people;

FIG. 16 is a schematic diagram illustrating an example of arrangement of first light emitting elements, second light emitting elements, and third light emitting elements according to Embodiment 2;

FIG. 17 is a block diagram illustrating a main control configuration of a lighting apparatus according to Embodiment 2;

FIG. 18 is a block diagram illustrating a main control configuration of a lighting apparatus according to Embodiment 3; and

FIG. 19 is a graph illustrating a relation for each of middle aged people (45 to 64 years old) and older aged people (aged 65 and over) between the FCI percentage of illumination light and the correctness percentage of identifying a color of red paper.

### DETAILED DESCRIPTION OF THE EMBODIMENTS

The following specifically describes embodiments, with reference to the drawings. The embodiments described below each show a general or specific example. The numerical values, shapes, materials, elements, the arrangement and connection of the elements, and others indicated in the following embodiments are mere examples, and therefore are not intended to limit the present disclosure. Thus, among the elements in the following exemplary embodiments, elements not recited in any independent claim defining the most generic concept are described as arbitrary elements. It should be noted that the drawings are schematic diagrams, and do not necessarily provide strictly accurate illustration.

### Embodiment 1

### [Entire Configuration]

The following describes a lighting apparatus according to Embodiment 1.

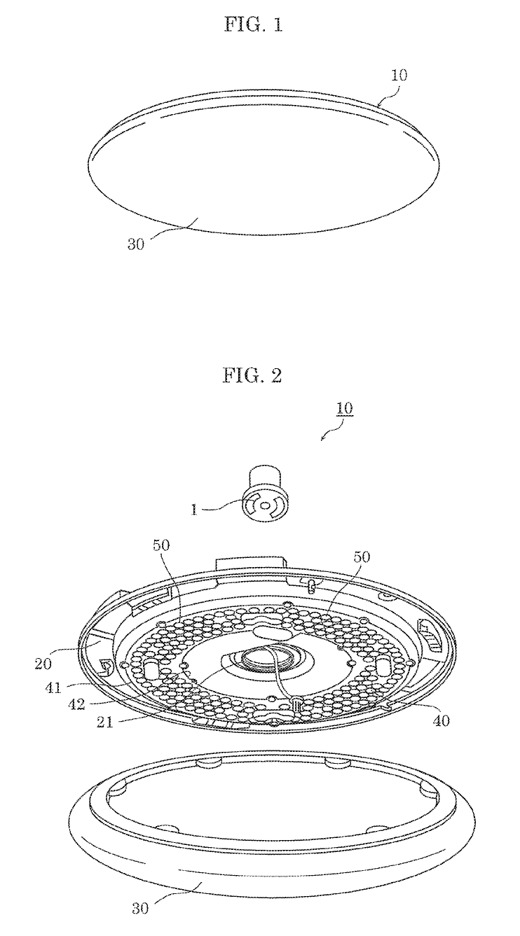

FIG. 1 is a perspective view illustrating a schematic structure of the lighting apparatus according to Embodiment 1. FIG. 2 is an exploded perspective view illustrating a schematic structure of the lighting apparatus according to Embodiment 1.

As illustrated in FIGS. 1 and 2, lighting apparatus 10 includes device body 20, cover 30, and light emitter 40. Lighting apparatus 10 is detachably attached to, for example, hook ceiling body 1 provided on the ceiling of a building such as a house, for example.

Device body 20 is a casing for supporting cover 30 and light emitter 40. Device body 20 is formed in a ring shape having circular opening 21 in the center portion. Hook ceiling body 1 is connected to light emitter 40 through opening 21.

Note that device body 20 is formed in the stated shape by performing press working on sheet metal such as an aluminum plate or a steel plate, for example. In order to increase reflexibility to improve light extraction efficiency, white coating is applied onto or a reflective metal material is vapor-deposited onto an inner surface (floor-side surface) of device body 20.

Cover 30 is an external cover for covering the entire inner surface of device body 20, and is detachably attached to device body 20. Accordingly, light emitter 40 is disposed inside cover 30. Cover 30 is formed in a circular dome shape. Cover 30 is formed of a light-transmissive resin material such as, for example, acrylics (PMMA), polycarbonate (PC), polyethylene terephthalate (PET), or polyvinyl chloride (PVC). Accordingly, light emitted by light emitter 40 toward the inner surface of cover 30 passes and exits through cover 30. Note that cover 30 may be given light diffusibility by forming cover 413 with a semi-opaque resin material.

Light emitter 40 is a light source for emitting white light, for example. Specifically, light emitter 40 includes substrate 41, and light emitting elements 50 mounted on a mounting surface (floor-side surface) of substrate 41.

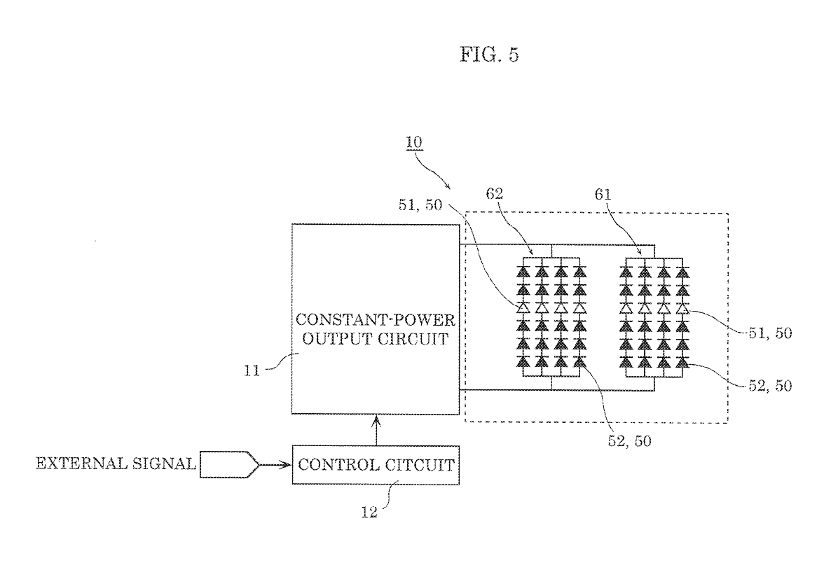

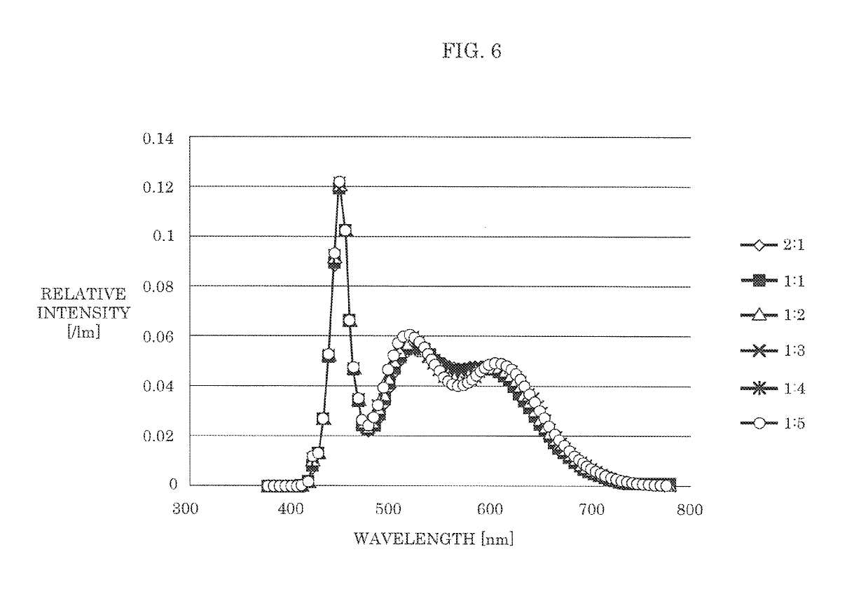

Substrate 41 is a printed-circuit board for mounting light emitting elements 50, and is formed in a ring shape having circular opening 42 in the center portion. A wiring pattern (not illustrated) for mounting light emitting elements 50 is formed on substrate 41. The wring pattern is for supplying direct current from a circuit portion (including constant-power output circuit 11 and control circuit 12: see FIG. 5) to light emitting elements 50, by electrically connecting light emitting elements 50 to the circuit portion.

Light emitting elements 50 are arranged on substrate 41 in multiple rings. Light emitting elements 50 are, for example, packaged surface-mount white LED elements (SMDs: surface mount devices). Light emitting elements 50 include first light emitting elements 51 and second light emitting elements 52.

First light emitting elements 51 and second light emitting elements 52 have chromaticity values in the same chromaticity range. Here, the “same chromaticity range” is a range for one of light source colors (daylight color, day white color, white color, warm white color, and electric lamp color) standardized in JIS Z9112-2012 “Classification of fluorescent lamps and light emitting diodes by chromaticity and colour rendering property.” For example, if first light emitting elements 51 have chromaticity values that fall within the chromaticity range for daylight color, second light emitting elements 52 also have chromaticity values that fall within the chromaticity range for daylight color.

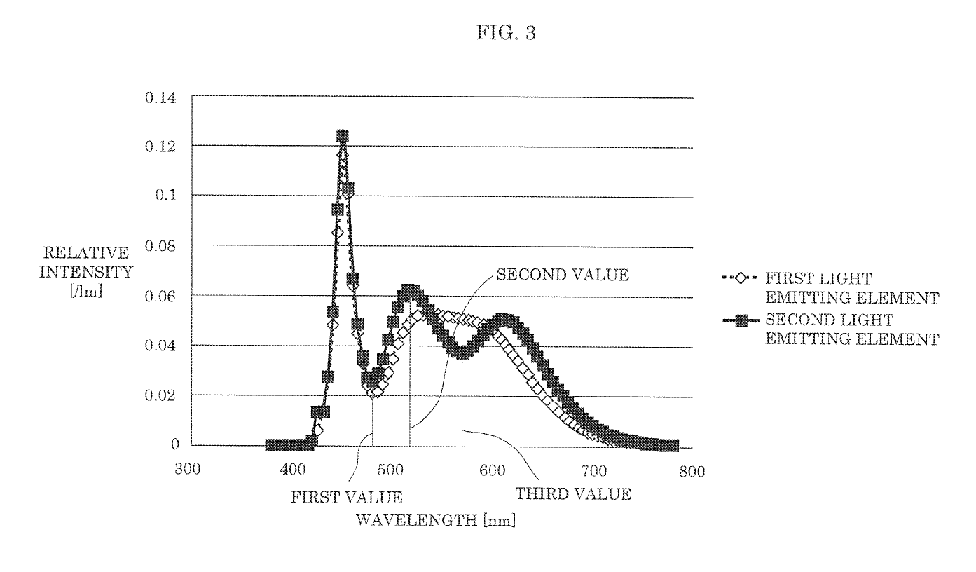

FIG. 3 is a graph illustrating examples of spectral characteristics of first light emitting elements 51 and second light emitting elements 52 according to Embodiment 1.

As illustrated in FIG. 3, first light emitting elements 51 have a spectral distribution with a first peak wavelength in a range of 425 nm to 480 nm inclusive, and a second peak wavelength in a range of 500 nm to 560 nm inclusive. Second light emitting elements 52 have a spectral distribution with a first peak wavelength in a range of 425 nm to 480 nm inclusive, a second peak wavelength in a range of 500 nm to 560 nm inclusive, and a third peak wavelength in a range of 580 nm to 650 nm inclusive.

Comparison between first light emitting elements 51 and second light emitting element 52 shows that the spectral characteristics of first light emitting elements 51 have a higher priority to light emission efficiency than those of second light emitting elements 52. In contrast, the spectral characteristics of second light emitting elements 52 have a higher priority to a color rendering property than those of first light emitting elements 51.

Here, in FIG. 3, a local maximum at the second peak wavelength of the spectral characteristics of second light emitting elements 52 is a second value, a local minimum on the negative side relative to the second value is a first value, and a local minimum on the positive side relative to the second value is a third value. In the example in FIG. 3, the first value is 480 nm, the second value is 520 nm, and the third value is 570 nm.

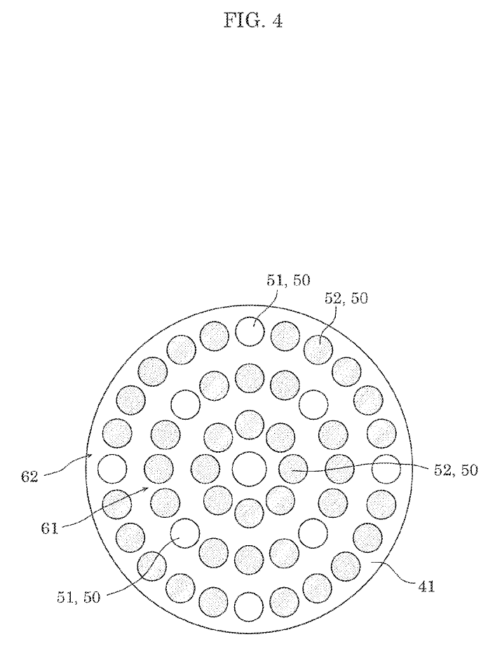

FIG. 4 is a schematic diagram illustrating an example of the arrangement of first light emitting elements 51 and second light emitting elements 52 according to Embodiment 1. As illustrated in FIG. 4, first light emitting elements 51 and second light emitting elements 52 are arranged on substrate 41 in triple rings. Here, the innermost ring is formed by 8 second light emitting elements 52. The middle ring is formed by 4 first light emitting elements 51 and 12 second light emitting elements 52. The outermost ring is formed by 4 first light emitting elements 51 and 20 second light emitting elements 52. In the middle and outermost rings, first light emitting elements 51 are arranged at regular intervals along the circumference. Accordingly, first light emitting elements 51 are arranged almost evenly along the circumference. First light emitting elements 51 and second light emitting elements 52 which form the innermost and middle rings constitute first light emitting module 61, and first light emitting elements 51 and second light emitting elements 52 which form the outermost ring constitute second light emitting module 62.

FIG. 5 is a block diagram illustrating a main control configuration of lighting apparatus 10 according to Embodiment 1.

As illustrated in FIG. 5, lighting apparatus 10 includes constant-power output circuit 11 and control circuit 12.

Constant-power output circuit 11 is a circuit for supplying constant power to light emitting elements 50.

Control circuit 12 controls constant-power output circuit 11 when an external signal for lighting is input by, for example, a light-on switch which is not illustrated being turned on, and causes light emitting elements 50 to emit light.

Light emitting elements 50 are divided into a plurality of groups, and the groups of light emitting elements 50 are electrically connected parallel to constant-power output circuit 11. Specifically, eight groups in total each including one first light emitting element 51 and five second light emitting elements 52 are provided. One first light emitting element 51 and five second light emitting elements 52 in each group are electrically connected in series. When the eight groups are divided into two sets each including four groups, and one set serves as first light emitting module 61 and the other set serves as second light emitting module 62, first light emitting module 61 and second light emitting module 62 are electrically connected parallel to constant-power output circuit 11.

In this manner, control circuit 12 can control light emitting elements 50 and 51 using current having the same value, by controlling constant-power output circuit 11.

### [Combined Light]

The following describes combined light which is a combination of light emitted by first light emitting elements 51 and light emitted by second light emitting elements 52.

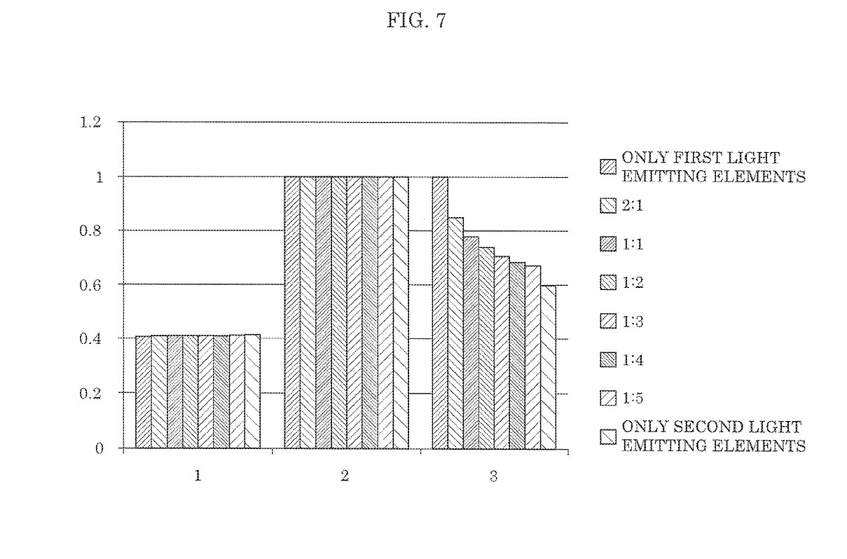

FIG. 6 is a graph illustrating, when the ratio in number of first light emitting elements 51 to second light emitting elements 52 according to Embodiment 1 is changed, spectral distributions of combined light at the ratios in number.

FIG. 6 illustrates spectral distributions of combined light when the ratio in number of first light emitting elements 51 to second light emitting elements 52 is 2:1, 1:1, 1:2, 1:3, 1:4, and 1:5. Based on the results, proportions of relative intensities (relative intensity ratios) at the first value and the third value of spectral distributions of light emitted by the light emitting elements having the ratios in number were calculated, when the relative intensities at the second value were assumed to be 1.

FIG. 7 is a graph illustrating changes of relative intensity ratios at the first value and the third value of spectral distributions of light emitted by the light emitting elements having the ratios in number according to Embodiment 1, when the relative intensities at the second value are 1.

FIG. 7 shows that the relative intensity ratios at the first value do not show significant changes at any spectral distributions, yet the relative intensity ratios at the third value decrease with an increase in the proportion of second light emitting elements 52.

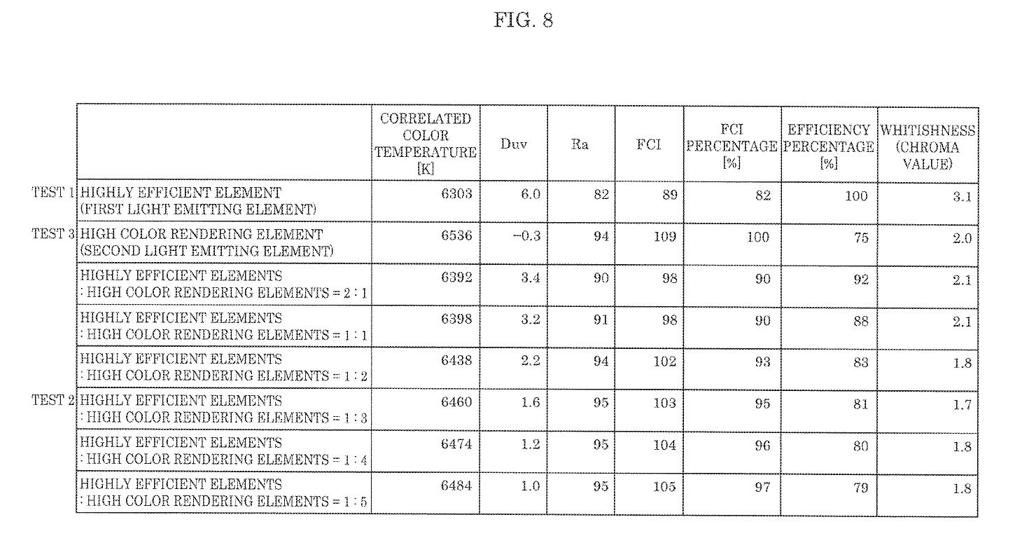

FIG. 8 is a table illustrating optical characteristics of entire lighting apparatus 10 at the ratios in number of first light emitting elements 51 to second light emitting elements 52 according to Embodiment 1.

The optical characteristics of entire lighting apparatus 10 are optical characteristics of combined light which is a combination of light emitted by first light emitting elements 51 and light emitted by second light emitting elements 52. As is clear from FIG. 8, at all the ratios in number, the correlated color temperatures of the combined light are at least 5700 K and at most 7100 K.

Here, a feeling of contrast index (FCI) is a so called index for distinctness and is proposed in, for example, Japanese Unexamined Patent Application Publication No. H09-120797. Specifically, FCI is a percentage of brightness perceived under standard light D65, based on color appearance.

When light emission efficiency achieved when only first light emitting elements 51 are used is 100%, the efficiency percentages are relatively calculated from light emission efficiency in other cases. When FCI achieved when only second light emitting elements 52 are used is 100%, the FCI percentages are relatively calculated from FCIs in other case.

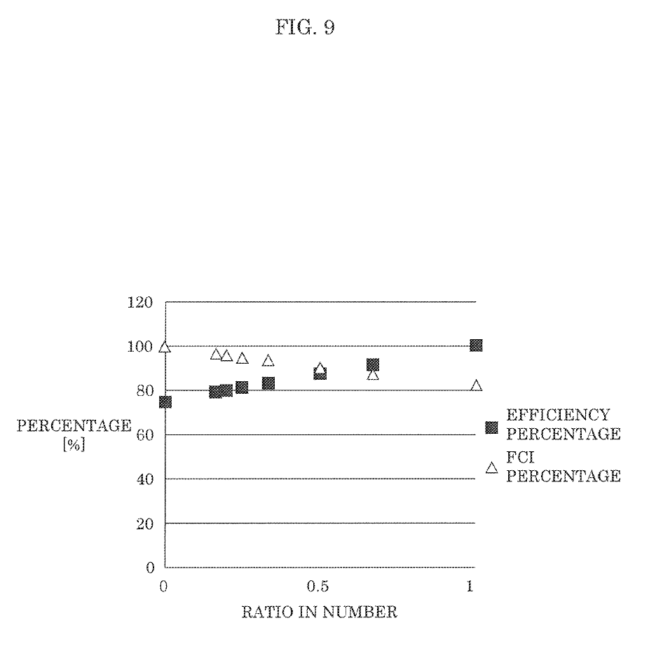

FIG. 9 is a graph illustrating a relation between proportion in number of first light emitting elements 51 to second light emitting elements 52 and the efficiency percentage and the FCI percentage in FIG. 8.

Here, the proportion in number is proportion of the number of first light emitting elements 51 disposed to the number of all light emitting elements 50 disposed. For example, if light emitting elements 50 include only first light emitting elements 51, the proportion in number is “1”, and if light emitting elements 50 include only second light emitting elements 52, the proportion in number is “0.” If the ratio in number of first light emitting elements 51 to second light emitting elements 52 is 2:1, the proportion in number is “0.67.” Similarly, if the ratio in number is 1:1, the proportion in number is “0.5,” if the ratio in number is 1:2, the proportion in number is “0.33,” if the ratio in number is 1:3, the proportion in number is “0.25”, if the ratio in number is 1:4, the proportion in number is “0.20,” and if the ratio in number is 1:5, the proportion in number is “0.17.”

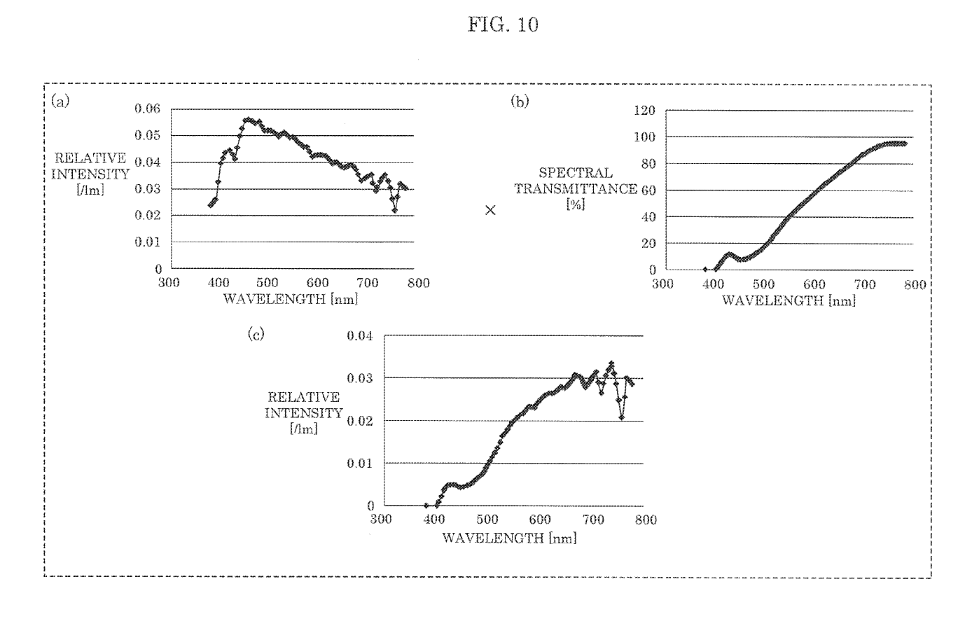

FIG. 10 is an explanatory diagram illustrating a spectral distribution of light emitted by a standard light source, a filter for middle and older aged people, and a spectral distribution obtained by applying the filter for middle and older aged people to the spectral distribution of light from the standard light source, according to Embodiment 1. Specifically, (a) in FIG. 10 is a graph illustrating a spectral distribution of light from a D65 light source used as a standard light source when a tint is evaluated. Part (b) of FIG. 10 is a graph illustrating a filter for middle and older aged people based on a difference obtained by subtracting spectral transmittance of middle and older aged viewers from spectral transmittance of viewers in maturing age. Part (c) of FIG. 10 is a graph illustrating a spectral distribution obtained by applying the filter for middle and older aged people in (b) of FIG. 10 to the spectral distribution in (a) of FIG. 10. Based on the spectral distribution in (c) of FIG. 10, how much the light color perceived by middle and older aged people varies relative to the light color perceived by the viewers in maturing age is estimated.

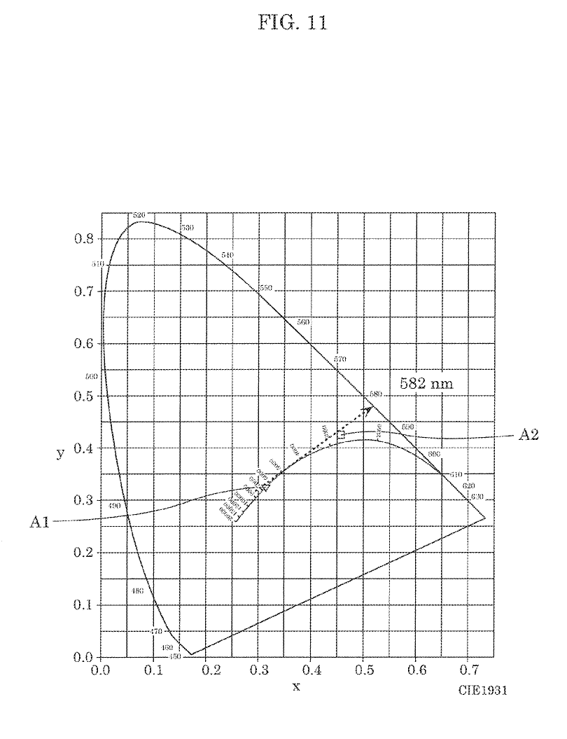

FIG. 11 is a chromaticity coordinate graph showing outputs of chromaticity coordinates A1 of the D65 light source in FIG. 10 and chromaticity coordinates A2 of the D65 light source when the filter for middle and older aged people is applied. As illustrated in FIG. 11, by applying the filter for middle and older aged people, the chromaticity coordinates indicating a color perceived by the observes changes from chromaticity coordinates A1 to chromaticity coordinates A2. Extending a straight line that connects chromaticity coordinates A1 and A2 shows that the chromaticity in a wavelength range near 582 nm is increasing for the middle and older aged people. Accordingly, a relative intensity in a wavelength range which includes 582 nm of combined light which is a combination of light emitted by first light emitting elements 51 and light emitted by second light emitting elements 52 is decreased, and thus middle and older aged people can perceive a color indicated by similar chromaticity to that of the viewers in maturing age. Here, the wavelength range which includes 582 nm includes a wavelength whose relative intensity is the lowest in a range of 500 nm to 650 nm inclusive in a spectral distribution, and specifically is a wavelength range which includes the third value.

### [Verification Experiment]

The inventors examined, by the experiment, influence given by FCI percentages on how colors appear to viewers.

The summary of the experiment is as follows.

The color of reference light (correlated color temperature: 6200 K) was adjusted by mixing light emitted by highly efficient first light emitting elements 51 having a high color temperature (correlated color temperature: 6300 K) and light emitted by highly efficient light emitting elements (third light emitting elements) having a low color temperature (correlated color temperature: 2400 K). Three types of test light were adjusted to have 6200 K by changing the ratio of first light emitting elements 51 to high color rendering second light emitting elements 52 having a high color temperature (correlated color temperature: 6500 K) and further adding third light emitting elements. Specifically, test 1 light was adjusted to have 6200 K by adding the third light emitting elements to a group of only first light emitting elements 51. Test 2 light was adjusted to have 6200 K by adding the third light emitting elements to a group of first light emitting elements 51 and second light emitting elements 52 whose ratio in number is 1 to 3. Test 3 light was adjusted to have 6200 K by adding the third light emitting elements to a group of only second light emitting elements 52.

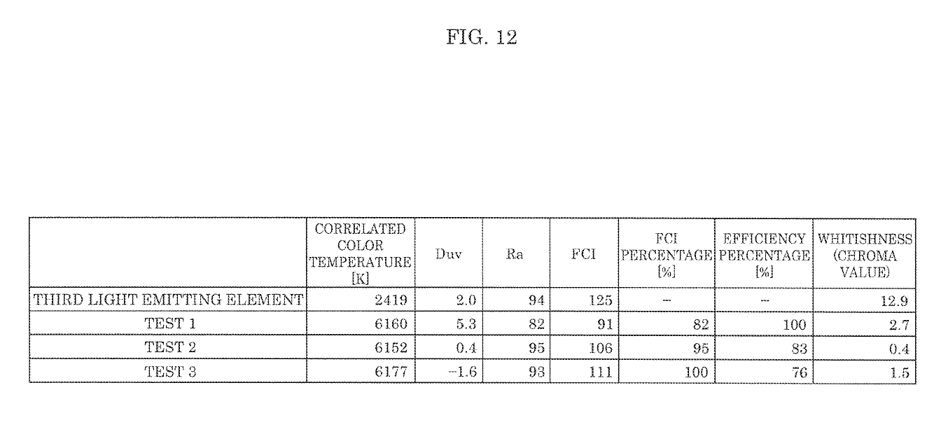

FIG. 12 is a table illustrating optical characteristics of light emitted by the third light emitting elements and test 1 light to test 3 light used for color mixture in this experiment.

Here, the eyes of accommodative power have a peak at the age of 10 and gradually decreases, and when the person is over 45, he/she starts perceiving a subjective symptom such as “unclear appearance of small letters” and “blurred vision.” This is the beginning of “presbyopia.” Subjects for this experiment were 15 people including 9 people in middle age, that is, aged 46 to 62, who already have a sign of presbyopia and 6 people in maturing age, that is, aged 27 to 37, who have not had a sign of presbyopia.

A φ120 downlight which emits the reference light and φ120 downlights which emit test 1 light, test 2 light, and test 3 light were disposed in evaluation boxes (size: W300×D300×H500 [mm]/interior color: N7 for walls and N5 for bottom). The positions of the evaluation boxes were switched between right and left, and the experiment was conducted two times for each of the eyes.

Objects to be viewed were Munsell color paper (hue, value/chroma: 5R4/14, 5R4/13, 5R4/12, 5R4/11, 5R4/10, 5R4/9; 5Y8/14, 5Y8/13, 5Y8/12, 5Y8/11, 5Y8/10, 5Y8/9; 5G4/10, 5G4/9, 5G4/8, 5G4/7, 5G4/6, 5G4/5; 10B4/10, 10B4/9, 10B4/8, 10B4/7, 10B4/6, 10B4/5) made by General Incorporated Foundation, Japan Color Research Institute.

In this experiment, in order to take into consideration the influence from whether the right or left eye is the dominant eye, one piece of color paper of each hue having second highest chroma (5R4/13, 5Y8/13, 5G4/9, or 10B4/9 paper) is placed under reference light, and six pieces of color paper of each hue having six chroma levels were disposed under test 1 light to test 3 light.

The evaluation method was that how color paper appears to one of the eyes under the reference light was compared with how color paper appears to the other eye under test 1 light to test 3 light, and a subject selected one of six pieces of color paper, which the subject thought to be as “vivid” as the color paper under the reference light by paired comparison. The subject was allowed to select a color between two pieces of color paper.

The experiment was conducted following the procedure below.

When the illuminance of the reference light was 500 lx and the illuminance of test 1 to test 3 light was 500 lx, a subject took three minutes to adapt one of the eyes to N5 colored paper in the reference light evaluation box and the other eye to one of the test 1 to test 3 evaluation boxes. After that, a piece of red paper, 5R4/13, was placed in the reference light evaluation box, and pieces of red paper, 5R4/14, 5R4/13, 5R4/12, 5R4/11, 5R4/10, and 5R4/9, were placed in each of the test 1 to test 3 evaluation boxes. Then, the subject selected one of the pieces of red paper that appears as “vivid” as the red paper under the reference light. Subsequently, the subject made evaluation similarly in the hue order of yellow, green, and blue. After the evaluation box was changed to the test 1, test 2, or test 3 evaluation box, the subject took one minute to adapt to the test light, and repeatedly made evaluation.

The results of the experiment were as follows.

Differences between color paper of the hues (5R4/13, 5Y8/13, 5G4/9, 10B4/9) in the test 1 evaluation box that appeared as vivid as color paper in the reference light box and selected color paper in the test 2 and 3 evaluation boxes which appeared as “vivid” as color paper in the reference light box (chroma difference=chroma of selected color paper under test 1 light−chroma of selected color paper under test 2 or 3 light) were averaged for four hues.

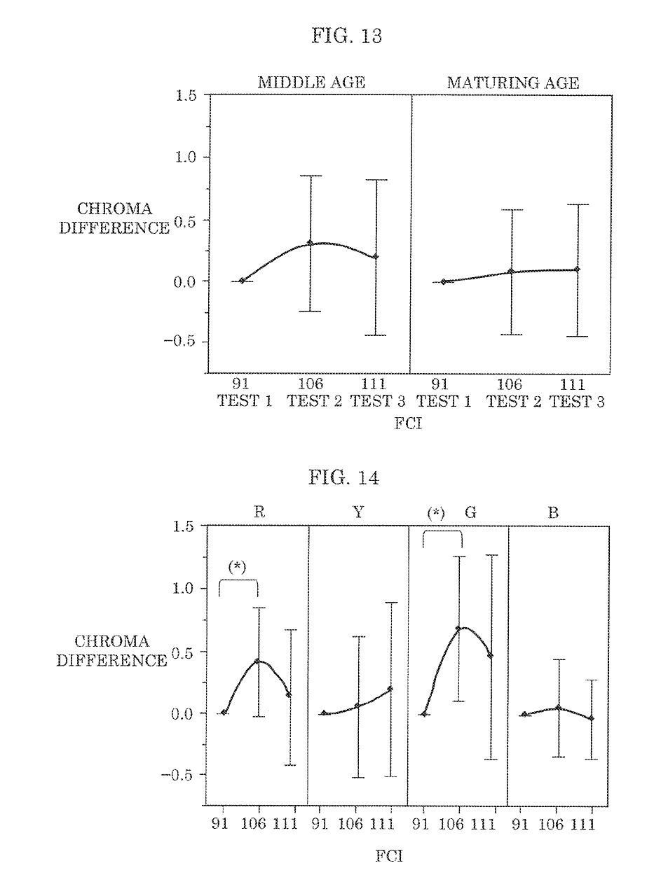

FIG. 13 is a graph illustrating relations between a chroma difference obtained by the experiment and test 1 light to test 3 light, separately for middle aged people and maturing aged people. FIG. 14 is a graph illustrating relations between test 1 light to test 3 light and chroma differences for the four hues for middle aged people.

As is clear from FIG. 13, more noticeable increase in chroma depending on spectra is achieved for middle aged people than for maturing aged people, and test 2 light and test 3 light achieve substantially the same effects. Furthermore, as is clear from FIG. 14, for middle aged people, test 2 illumination light yielded more noticeable increase in chroma of green (G) paper and red (R) paper, than test 1 illumination light. Although increase in chroma of yellow (Y) is not noticeable, an increase in FCI is slightly yielded for yellow (Y). In contrast. FCI is slightly decreased for blue (B).

The above results show that test 1 light and test 2 light improved appearance of red and green. At 6200 K, a difference in FCI between test 1 light and test 2 light is 15, and a difference in FCI between test 2 light and test 3 light is 5. If a difference between FCIs is 10 or more, it can be said that the difference improves appearance of red and green for middle aged people. According to the above condition, FCI of test 1 light higher than 91 by 10 or more is 101 or more. The correlated color temperatures of test 1 light to test 3 light are 6200 K, which is achieved by mixing light emitted by first light emitting elements 51, second light emitting elements 52, and the third light emitting elements. In this manner, FCI is higher by about 3 than FCI of light which has a correlated color temperature of 6500 K and is a combination of light emitted by only first light emitting elements 51 and second light emitting elements 52. Accordingly, the table illustrated in FIG. 8 shows that FCI may have a numerical value of at least 98, and the number of second light emitting elements 52 may be greater than the number which constitutes 2:1 which is the ratio in number of first light emitting elements 51 to second light emitting elements 52.

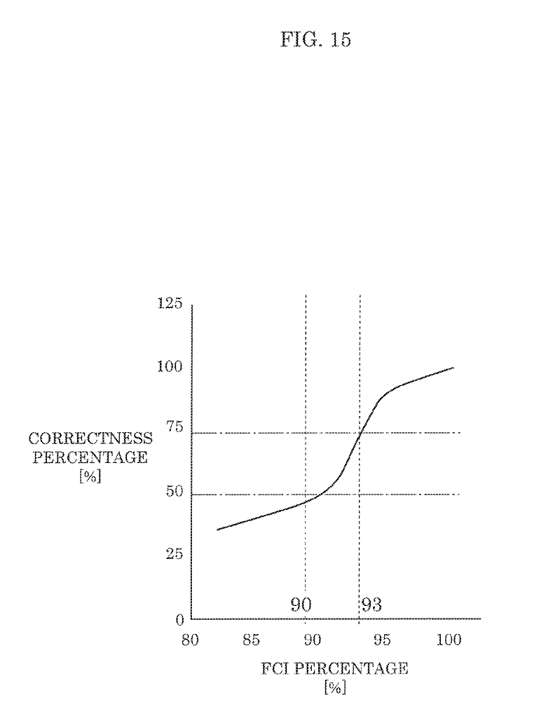

FIG. 15 is a graph illustrating a relation between the FCI percentage of the illumination light and the correctness percentage of identifying the color of red paper, for middle aged people (45 to 64 years old).

Under light from one of light sources which emit light having different FCIs, three pieces of red paper arranged at constant intervals were presented to a subject, and if the subject thought that the three pieces of red paper included different red paper, the subject answered the position of the different red paper. The correctness percentage indicates the percentage of subjects who correctly indicated the position. In the experiment, 5R4/11 was used as a reference color, and three pieces of the same color paper and three pieces of color paper that include one color paper having chroma indicated by 5R4/11.5, 5R4/12, 5R4/12.5, 5R4/13, 5R4/13.5, or 5R4/14 were presented. If the three pieces of color paper were the same, the subject answered “the same”, and if the three pieces of color paper include different color paper, the subject answered the position “left, middle, or right”. The graph in FIG. 15 indicates the correctness percentage when the three pieces of red paper include 5R4/11.5 color paper.

As is clear from FIG. 15, the correctness percentage is 50% or higher if the FCI percentage is greater than 90. In other words, based on the ratio in number of first light emitting elements 51 to second light emitting elements 52 which achieves the FCI percentage of 90 or higher, the numbers of first light emitting elements 51 and second light emitting elements 52 to be disposed may be determined. FIGS. 8 and 9 show that the ratio in number which achieves the FCI percentage of 90 or higher is 2:1. In other words, if the percentage of second light emitting elements 52 relative to first light emitting elements 51 is equal to or higher than 2:1 which is the ratio in number of first light emitting elements 51 to second light emitting elements 52, the color perception percentage of middle and older aged people can be secured to a certain degree. Note that the color perception percentage is to be increased to 75% or higher, the ratio in number which achieves a FCI percentage of 93 or higher may be selected.

As is clear from FIG. 7, if the total number of second light emitting elements 52 is half the total number of first light emitting elements 51 or greater, the relative intensity ratios of light having the third value when the relative intensity at the second value is 1 is 0.85 or lower in either case. Specifically, regarding a spectral distribution of combined light which is a combination of light emitted by first light emitting elements 51 and light emitted by second light emitting elements 52, a ratio of the greatest value (relative intensity at the second value) in a range of 500 nm to 560 nm inclusive to the smallest value (relative intensity at the third value) in a range of 500 nm to 650 nm inclusive is 0.85 or less, the color perception percentage of middle and older aged people can be secured to a certain degree.

As described above, according to the present embodiment, lighting apparatus 10 includes: first light emitting elements 51; and second light emitting elements 52 having chromaticity values in a same chromaticity range as first light emitting elements 51. A spectral distribution of light emitted by first light emitting elements 51 includes a first peak wavelength in a range of 425 nm to 480 nm inclusive, and a second peak wavelength in a range of 500 nm to 560 nm inclusive. A spectral distribution of light emitted by second light emitting elements 52 includes a first peak wavelength in a range of 425 nm to 480 nm inclusive, a second peak wavelength in a range of 500 nm to 560 nm inclusive, and a third peak wavelength in a range of 580 nm to 650 nm inclusive. A ratio of a greatest value of a spectral distribution of combined light in a range of 500 nm to 560 nm inclusive to a smallest value of the spectral distribution of the combined light in a range of 500 nm to 650 nm inclusive is 0.85 or less, the combined light being a combination of the light emitted by first light emitting elements 51 and the light emitted by second light emitting elements 52.

Accordingly, a ratio of the greatest value of a spectral distribution of combined light in a range of 500 nm to 560 nm inclusive to the smallest value of the spectral distribution of the combined light in a range of 500 nm to 650 nm inclusive is 0.85 or less, the combined light being a combination of light emitted by first light emitting elements 51 and light emitted by second light emitting elements 52. Thus, the color perception percentage of middle and older aged people can be increased. If the color perception percentage of middle and older aged people can be increased in the above manner, the saturation of colors of letters and objects viewed can be prevented from appearing lower to the middle and older aged people.

First light emitting elements 51 and second light emitting elements 52 are connected in series or parallel, and are controllable by current having a same current value.

Accordingly, first light emitting elements 51 and second light emitting elements 52 can be controlled by current having the same value, and thus the same driving source can be used for first light emitting elements 51 and second light emitting elements 52.

The combined light which is a combination of the light emitted by first light emitting elements 51 and the light emitted by second light emitting elements 52 has a correlated color temperature of at least 5700 K and at most 7100 K.

Accordingly, the combined light has a correlated color temperature of at least 5700 K and at most 7100 K, and thus the saturation of colors of letters and objects viewed can be more reliably prevented from appearing lower to middle and older aged people.

### Embodiment 2

The following describes Embodiment 2. Note that in the following description, the same element as the above embodiment may be given the same numeral, and a description of the element may be omitted.

Embodiment 1 has described an example in which lighting apparatus 10 which includes first light emitting elements 51 and second light emitting elements 52, whereas Embodiment 2 describes lighting apparatus 10A which includes third light emitting elements 53, in addition to first light emitting elements 51 and second light emitting elements 52.

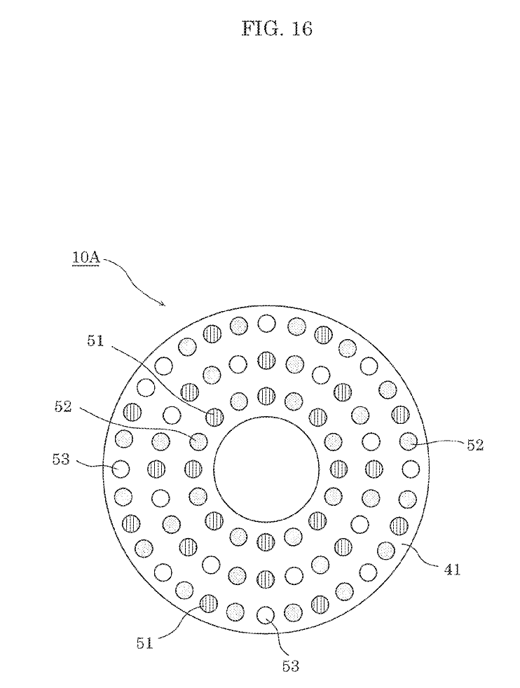

FIG. 16 is a schematic diagram illustrating an example of arrangement of first light emitting elements 51, second light emitting elements 52, and third light emitting elements 53 according to Embodiment 2.

As illustrated in FIG. 16, first light emitting elements 51, second light emitting elements 52, and third light emitting elements 53 are arranged on substrate 41 in triple rings. Here, in the innermost ring, 8 first light emitting elements 51 and 8 second light emitting elements 52 are alternately arranged one by one along the circumference. Stated differently, one of first light emitting elements 51 and one of second light emitting elements 52 are alternately arranged along the circumference of the innermost ring of the plurality of rings. In the middle ring, 8 first light emitting elements 51, 8 second light emitting elements 52, and 8 third light emitting elements 53 are arranged one by one in the order along the circumference. Stated differently, one of first light emitting elements 51, one of second light emitting elements 52, and one of third light emitting elements 53 are alternately arranged along the circumference of the middle ring of the plurality of rings. In the outermost ring, 8 first light emitting elements 51, 16 second light emitting elements 52, 8 third light emitting elements 53 are arranged along the circumference in a predetermined order. Stated differently, one of first light emitting elements 51, two of second light emitting elements 52, and one of third light emitting elements 53 are serially arranged in a predetermined order along the circumference of the outermost ring of the plurality of rings.

Accordingly, first light emitting elements 51, second light emitting elements 52, and third light emitting elements 53 are disposed dispersedly on substrate 41 (in a predetermined region), and a greater number of third light emitting elements 53 are disposed in the edge portion of substrate 41 than in the center portion.

The correlated color temperature of light emitted by third light emitting elements 53 is between 2600 K and 5700 K inclusive, and is lower than the color temperatures of light emitted by first light emitting elements 51 and second light emitting elements 52. Accordingly, since a greater number of third light emitting elements 53 are disposed in the edge portion of substrate 41 than in the center portion, light having a high color temperature is emitted immediately under lighting apparatus 10A, and light having a low color temperature is emitted in the periphery. Thus, lighting apparatus 10A emits, from the edge portion, light having a lower color temperature than from the center portion. Thus, middle and older aged people who are immediately under lighting apparatus 10A can be prevented from perceiving glare due to light from the edge portion.

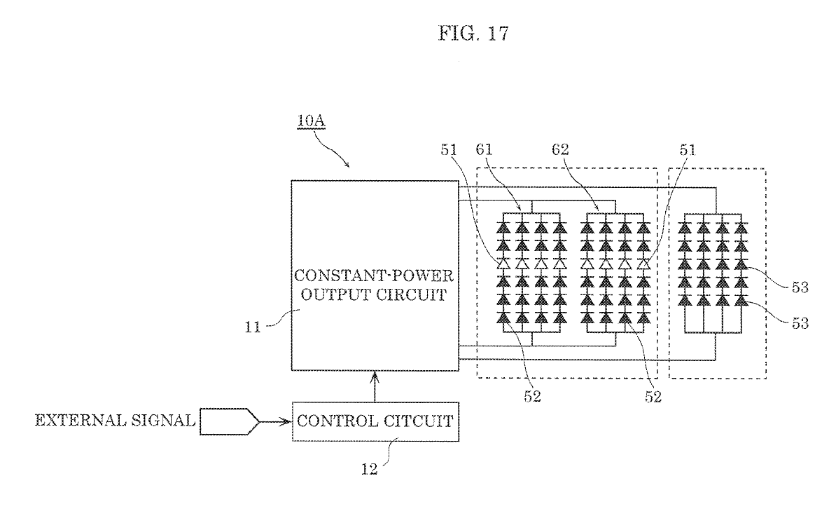

FIG. 17 is a block diagram illustrating a main control configuration of lighting apparatus 10A according to Embodiment 2. Specifically, FIG. 17 corresponds to FIG. 5.

As illustrated in FIG. 17, third light emitting elements 53 are electrically connected to constant-power output circuit 11 of lighting apparatus 10A by different lines from those of first light emitting module 61 and second light emitting module 62. Accordingly, by controlling constant-power output circuit 11, control circuit 12 controls first light emitting elements 51 and second light emitting elements 52 using current having the same value, and furthermore, can control third light emitting elements 53 using current having a value different from that of current for controlling first light emitting elements 51 and second light emitting elements 52. Thus, the color of light from entire lighting apparatus 10A can be adjusted.

Note that if the color of light from entire lighting apparatus 10A is not adjusted, a combination of first light emitting elements 51, second light emitting elements 52, and third light emitting elements 53 which produces light having a predetermined light color is disposed in one circuit, and the light emitting elements in the combination may be controlled by current having the same value.

### Embodiment 3

The following describes Embodiment 3.

Embodiment 1 has described an example in which first light emitting module 61 and second light emitting module 62 each include both types of first light emitting elements 51 and second light emitting elements 52, and furthermore, first light emitting module 61 and second light emitting module 62 can be controlled by current having the same value. Embodiment 3 describes the case where the first light emitting module and the second light emitting module each include one type of light emitting elements, and furthermore the first light emitting module and the second light emitting module are connected to the constant-power output circuit by different lines.

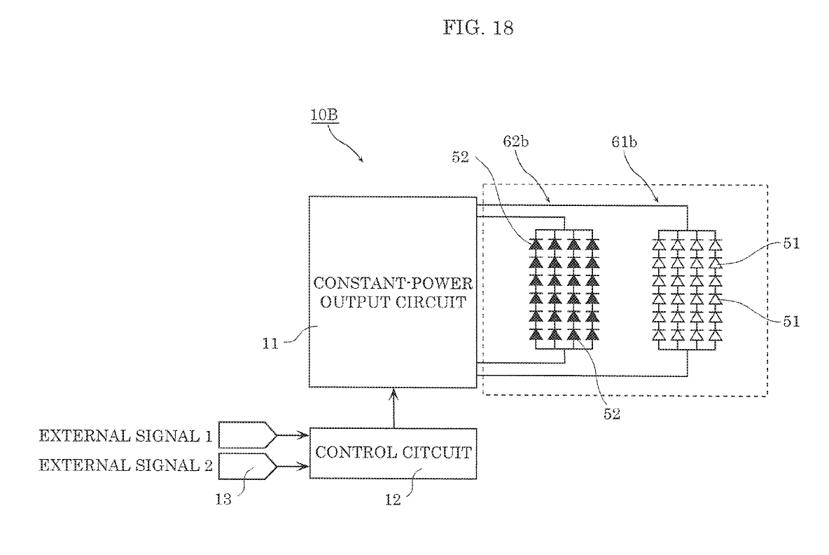

FIG. 18 is a block diagram illustrating a main control configuration of lighting apparatus 10B according to Embodiment 3. Specifically, FIG. 18 corresponds to FIG. 5.

As illustrated in FIG. 18, first light emitting module 61b of lighting apparatus 10B includes only first light emitting elements 51, and second light emitting module 62b includes only second light emitting elements 52. First light emitting module 61b and second light emitting module 62b are electrically connected to constant-power output circuit 11 by different lines. In this manner, first light emitting module 61b and second light emitting module 62b can be controlled by current having different values. Accordingly, a ratio of light emitted by first light emitting elements 51 to light emitted by second light emitting elements 52 can be adjusted.

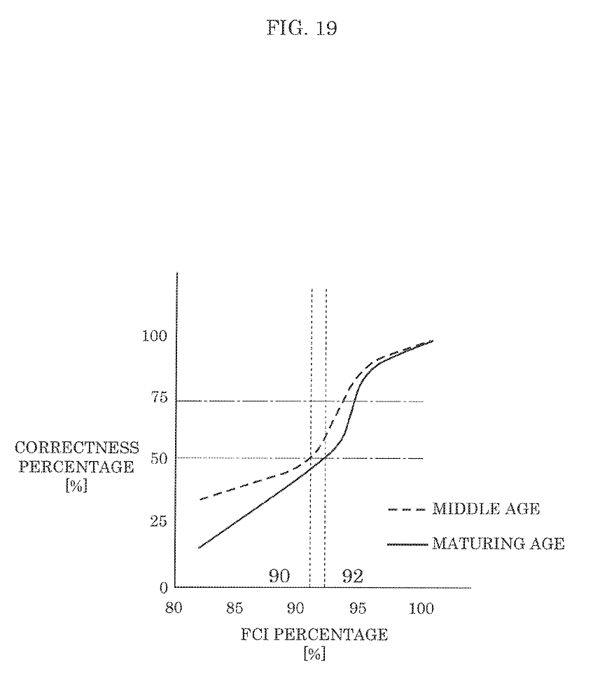

FIG. 19 is a graph illustrating a relation for each of middle aged people (45 to 64 years old) and older aged people (aged 65 and over) between the FCI percentage of illumination light and the correctness percentage of identifying a color of red paper.

As illustrated in FIG. 19, if the viewer's age is different, the relation between the FCI percentage and the correctness percentage is also different. For example, the FCI percentage at which the correctness percentage is 50% or higher is 90% or higher for middle aged people, but is 92% or higher for older aged people. Accordingly, even if the color perception percentage is to be maintained constant, the FCI percentage is different depending on age, and thus a desired color perception percentage can be secured for different ages by adjusting the ratio of light emitted by first light emitting elements 51 to light emitted by second light emitting elements 52.

For example, as illustrated in FIG. 18, if two external signals are input to control circuit 12, one external signal (external signal 1) is assumed to be a lighting signal, and the other external signal (external signal 2) is assumed to be a signal which includes information indicating the age of a viewer. Register 13 which inputs the other external signal to control circuit 12 when a user inputs his/her age, creates an external signal which includes information indicating the age, and inputs the external signal to control circuit 12.

In order to achieve age-dependent appropriate ratios of light emitted by first light emitting elements 51 to light emitted by second light emitting elements 52, control circuit 12 stores in advance values of current which flows through first light emitting elements 51 and second light emitting elements 52. Upon the input of the other external signal, control circuit 12 obtains an age from the external signal, and reads a value of current which flows through first light emitting elements 51 for the age and a value of current which flows through second light emitting elements 52 for the age. By controlling constant-power output circuit 11 based on the read values of current, control circuit 12 causes first light emitting elements 51 and second light emitting elements 52 to emit light at the ratio of light emission for the input age. In this manner, first light emitting elements 51 and second light emitting elements 52 can be caused to emit light at an age-dependent ratio of light emission, and thus a constant color perception percentage can be secured for any age.

### Other Embodiments

The above has described the lighting apparatuses according to the embodiments, yet the present disclosure is not limited to the above embodiments.

For example, first light emitting elements 51 may have a spectral emission property defined by a correlated color temperature of light being at least 5400 K and at most 7000 K, Duv being in a range of −6 to 5 inclusive, a chroma value calculated using a calculation method specified in the CIE 1997 Interim Color Appearance Model (Simple Version) being 2.7 or less, and general color rendering index Ra being 80 or more. Here, the chroma value is an index for quantitatively evaluating whitishness of an object to be viewed. Chromaticness is high when the chroma value is large, whereas chromaticness is low when the chroma value is small. Accordingly, when the chroma value is small, whitishness is high. Under the light having a spectrum which achieves the chroma value of 2.7 or less, the correlated color temperature of at least 5400 K and at most 7000 K, and color deviation Duv in a range of −6 to 5 inclusive, the readability of printed letters on a piece of paper is increased, which is already known (for example. Japanese Unexamined Patent Application Publication No. 2014-75186). Furthermore, general color rendering index Ra is an index for evaluating faithful reproducibility of a color, and JIS Z9112 “Classification of fluorescent lamps and light emitting diodes by chromaticity and colour rendering property” shows a criterion for the index. Specifically, general color rendering index Ra may be 80 or more. If first light emitting elements 51 have the above spectral emission property, a color can be faithfully reproduced while readability of letters printed on a piece of paper is increased.

Furthermore, second light emitting elements 52 may have a spectral emission property defined by a correlated color temperature of light being lower than a correlated color temperature of light emitted by first light emitting elements 51.

Light emitted from the edge portion of the predetermined region may have a lower color temperature than light emitted from the center portion of the predetermined region.

The first light emitting elements, the second light emitting elements, and the third light emitting elements may be dispersedly disposed in a plurality of rings.

One of the first light emitting elements and one of the second light emitting elements may be alternately arranged along a circumference of an innermost ring of the plurality of rings.

One of the first light emitting elements, one of the second light emitting elements, and one of the third light emitting elements may be alternately arranged along a circumference of a middle ring of the plurality of rings.

One of the first light emitting elements, two of the second light emitting elements, and one of the third light emitting elements may be serially arranged in a predetermined order along a circumference of an outermost ring of the plurality of rings.

The first light emitting elements may include spectral characteristics having a higher priority to light emission efficiency than the second light emitting elements.

The second light emitting elements may include spectral characteristics having a higher priority to a color rendering property than the first light emitting elements.

The first light emitting elements and the second light emitting elements may be arranged in a plurality of rings.

Each of the plurality of rings may include at least one of the second light emitting elements.

An innermost ring of the plurality of rings may not include any of the first light emitting elements.

At least one of a middle ring and an outermost ring of the plurality of rings may include one of the first light emitting elements arranged at regular intervals along a circumference of the one of the middle ring and the outermost ring.

The first light emitting elements and the second light emitting elements may be divided into a plurality of groups, and each of the plurality of groups may be electrically connected to a power output circuit in parallel.

Light emitting elements in each of the plurality of groups may be electrically connected in series.

Each of the plurality of groups may include a first predetermined number of the first light emitting elements and a second predetermined number of the second light emitting elements, the first predetermined number being different than the second predetermined number.

A total number of the second light emitting elements may be half a total number of the first light emitting elements or greater.

Note that aspects obtained by arbitrarily combining the configurations described in the above embodiment and the variation also fall within the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting apparatus, comprising:
first light emitting elements; and
second light emitting elements having chromaticity values in a same chromaticity range as the first light emitting elements, wherein
a spectral distribution of light emitted by the first light emitting elements includes a first peak wavelength in a range of 425 nm to 480 nm inclusive, and a second peak wavelength in a range of 500 nm to 560 nm inclusive,
a spectral distribution of light emitted by the second light emitting elements includes a first peak wavelength in a range of 425 nm to 480 nm inclusive, a second peak wavelength in a range of 500 nm to 560 nm inclusive, and a third peak wavelength in a range of 580 nm to 650 nm inclusive, and
a ratio of a greatest value of a spectral distribution of combined light in a range of 500 nm to 560 nm inclusive to a smallest value of the spectral distribution of the combined light in a range of 500 nm to 650 nm inclusive is 0.85 or less, the combined light being a combination of the light emitted by the first light emitting elements and the light emitted by the second light emitting elements.

2. The lighting apparatus according to claim 1, wherein
the first light emitting elements and the second light emitting elements are connected in series or parallel, and are controllable by current having a same current value.

3. The lighting apparatus according to claim 2, wherein
the combined light has a correlated color temperature of at least 5700 K and at most 7100 K.

4. The lighting apparatus according to claim 3, further comprising:
third light emitting elements which emit light having a correlated color temperature of at least 2600 K and at most 5700 K, wherein
the third light emitting elements are controllable by current having a different current value from the same current value of the current for controlling the first light emitting elements and the second light emitting elements.

5. The lighting apparatus according to claim 4, wherein
the first light emitting elements, the second light emitting elements, and the third light emitting elements are dispersedly disposed in a predetermined region, and
a greater number of the third light emitting elements are disposed in an edge portion of the predetermined region than in a center portion of the predetermined region.

6. The lighting apparatus according to claim 5, wherein
light emitted from the edge portion of the predetermined region has a lower color temperature than light emitted from the center portion of the predetermined region.

7. The lighting apparatus according to claim 5, wherein
the first light emitting elements, the second light emitting elements, and the third light emitting elements are dispersedly disposed in a plurality of rings.

8. The lighting apparatus according to claim 7, wherein
one of the first light emitting elements and one of the second light emitting elements are alternately arranged along a circumference of an innermost ring of the plurality of rings.

9. The lighting apparatus according to claim 7, wherein
one of the first light emitting elements, one of the second light emitting elements, and one of the third light emitting elements are alternately arranged along a circumference of a middle ring of the plurality of rings.

10. The lighting apparatus according to claim 7, wherein
one of the first light emitting elements, two of the second light emitting elements, and one of the third light emitting elements are serially arranged in a predetermined order along a circumference of an outermost ring of the plurality of rings.

11. The lighting apparatus according to claim 1, wherein
the first light emitting elements include spectral characteristics having a higher priority to light emission efficiency than the second light emitting elements.

12. The lighting apparatus according to claim 1, wherein
the second light emitting elements include spectral characteristics having a higher priority to a color rendering property than the first light emitting elements.

13. The lighting apparatus according to claim 1, wherein
the first light emitting elements and the second light emitting elements are arranged in a plurality of rings.

14. The lighting apparatus according to claim 13, wherein
each of the plurality of rings includes at least one of the second light emitting elements.

15. The lighting apparatus according to claim 13, wherein
an innermost ring of the plurality of rings does not include any of the first light emitting elements.

16. The lighting apparatus according to claim 13, wherein
at least one of a middle ring and an outermost ring of the plurality of rings includes one of the first light emitting elements arranged at regular intervals along a circumference of the one of the middle ring and the outermost ring.

17. The lighting apparatus according to claim 1, wherein
the first light emitting elements and the second light emitting elements are divided into a plurality of groups, and
each of the plurality of groups is electrically connected to a power output circuit in parallel.

18. The lighting apparatus according to claim 17, wherein
light emitting elements in each of the plurality of groups are electrically connected in series.

19. The lighting apparatus according to claim 18, wherein
each of the plurality of groups includes a first predetermined number of the first light emitting elements and a second predetermined number of the second light emitting elements, the first predetermined number being different than the second predetermined number.

20. The lighting apparatus according to claim 1, wherein
a total number of the second light emitting elements is half a total number of the first light emitting elements or greater.
